(19) United States
(12) Patent Application Publication
(10) Pub. No.: US 2014/0023568 A1
(43) Pub. Date: Jan. 23, 2014

(54) BIO CARTRIDGES

(71) Applicant: Electronics and Telecommunications Research Institute, Daejeon (KR)

(72) Inventors: Jongcheol HONG, Daejeon (KR); Wan Joong KIM, Goyang (KR); Gun Yong SUNG, Daejeon (KR); Seunghwan KIM, Daejeon (KR)

(21) Appl. No.: 13/937,151

(22) Filed: Jul. 8, 2013

(30) Foreign Application Priority Data
Jul. 19, 2012 (KR) 10-2012-0078845
Dec. 5, 2012 (KR) 10-2012-0140398

(51) Int. Cl. B01L 3/00

(52) U.S. Cl. CPC B01L 3/56
USPC 422/546; 422/554; 422/544

(57) ABSTRACT

A bio cartridge includes a reaction chamber disposed within a housing and containing a reagent, a specimen transfer channel providing a transfer path through which a specimen supplied to the housing is transferred into the reaction chamber, a mixing unit mixing the specimen with the reagent, and an air pressure unit providing air pressure to the specimen.

### CROSS-REFERENCE TO RELATED APPLICATIONS

This U.S. non-provisional patent application claims priority under 35 U.S.C. §119 to Korean Patent Application Nos. 10-2012-0078845 and 10-2012-0140398, filed on Jul. 19, 2012 and Dec. 5, 2012, the entirety of which is incorporated by reference herein.

### BACKGROUND

The inventive concept relates to bio cartridges and, more particularly, to bio cartridges capable of actively mixing a specimen with a reagent.

A bio cartridge is a diagnosis device which causes an electrical or optical signal variation according to unusual combination or reaction of a biological specimen and a reagent so as to quantitatively or qualitatively analyze and diagnose a target material. The bio cartridge may require smooth reaction of the biological specimen and the reagent, usage of a large biological specimen, and/or a relatively low manufacture costs.

### SUMMARY

Embodiments of the inventive concept may provide bio cartridges capable of diagnosing a large volume specimen.

Embodiments of the inventive concept may also provide bio cartridges capable of easily transferring a specimen.

Embodiments of the inventive concept may also provide bio cartridges capable of smoothly mixing a specimen with a reagent.

Embodiments of the inventive concept may also provide bio cartridges capable of being easily used by an ordinary person having no a technical skill.

In one aspect, a bio cartridge may include: a reaction chamber disposed in a housing, a reagent stored in the reaction chamber; a specimen transfer channel providing a transfer path through which a specimen supplied to the housing is transferred into the reaction chamber; a mixing unit mixing the specimen with the reagent; and an air pressure unit providing air pressure to the specimen.

In an embodiment, the housing may include a mounting region in which a specimen collection unit capable of collecting the specimen is mounted.

In an embodiment, the specimen transfer channel may have an inlet opened toward the mounting region.

In an embodiment, the housing may include an insertion part in which the specimen collection unit is inserted; the insertion part may be connected to the inlet; and a width of the insertion part may become progressively less toward the inlet of the specimen transfer channel.

In an embodiment, the air pressure unit may include: an air injecting needle capable of entering into the inside of the specimen collection unit; and an air transfer channel connected to the air injecting needle.

In an embodiment, the housing may include an air inhaling hole through which air is inhaled from the outside of the housing; the air pressure unit may be installed within the housing; the air transfer channel may be connected to the air inhaling hole; and the air injecting needle may protrude into the mounting region.

In an embodiment, the air pressure unit may be a distinct module that is not disposed within the housing.

In an embodiment, the housing may further include: a clamp installed in the mounting region and clamping the specimen collection unit.

In an embodiment, the mixing unit may include: a magnetic stirring unit disposed in the reaction chamber along with the reagent; and a rotating unit providing rotary power to the magnetic stirring unit. The rotating unit may include a motor having a magnet installed at an end of a rotating axis.

In an embodiment, the housing may include: an air exhaust channel connected to the reaction chamber, the air exhaust channel providing an exhaust path of air exhausted from the reaction chamber; and an air exhaust hole connected to the air exhaust channel, the air exhausted through the air exhaust hole.

In another aspect, a bio cartridge may include: a housing including a mounting region in which a specimen collection unit is mounted, the mounting region having an insertion part in which the specimen collection unit is inserted; a reaction chamber disposed in the housing, a reagent and a stirring unit disposed in the reaction chamber; a specimen transfer channel of which first and second ends are connected to the insertion part and the reaction chamber, respectively; a rotating unit disposed in the housing, the rotating unit generating power capable of rotating the stirring unit; and an air pressure unit providing air into the specimen collection unit to generate air pressure inside the specimen collection unit.

In an embodiment, the insertion part may include a protrusion protruding from a bottom surface of the mounting region. The protrusion may include an inner surface inclined downward toward the first end of the specimen transfer channel.

In an embodiment, the insertion part may include a recess region recessed from a bottom surface of the mounting region; and a width of the recess region may become progressively less from the bottom surface toward the first end of the specimen transfer channel.

In an embodiment, the rotating unit may include a motor having a magnet installed at an end of a rotating axis; and the stirring unit may have magnetism to rotate by operation of the motor.

In an embodiment, the air pressure may include: an air injecting needle providing air into the specimen collection unit; and an air transfer channel providing a path transferring the air to the air injecting needle. The air pressure unit may be disposed in the housing; and the air injecting needle may protrude into the mounting region so as to be inserted into the specimen collection unit.

In an embodiment, the housing may further include: a clamp installed in the mounting region. The clamp may be movable along a longitudinal direction of the specimen collection unit.

In still another aspect, a bio cartridge may include: a housing in which a reaction chamber is provided, the reaction chamber receiving a biological specimen from a pipet collecting the biological specimen and containing a reagent reacting with a target material in the biological specimen. The housing may include: an air pressure unit including an air injecting needle and an air transfer channel, the air injecting needle inserted into the pipet to provide air into the pipet, and the air transfer channel providing a path through which air injected from the outside of the housing is transferred to the air injecting needle; a specimen transfer channel providing a path through which the biological specimen is transferred from the pipet to the reaction chamber; and a mixing unit including a stirring unit disposed in the reaction chamber and a motor generating rotary power capable of rotating the stirring unit, the motor having a magnet installed at an end of a rotating axis. The air pressure unit may generate air pressure inside the pipet to transfer the biological specimen into the reaction chamber through the specimen transfer channel. The mixing unit may rotate the stirring unit by driving of the motor to mix the biological specimen transferred in the reaction chamber with the reagent stored in the reaction chamber.

In an embodiment, the housing may include a pipet mounting region defined by a recessed sidewall of the housing; an insertion part of a funnel-shape may be provided in the pipet mounting region; and the pipet may be inserted in the insertion part.

In an embodiment, the stirring unit may have a ball, bearing or bar shape having magnetism.

In an embodiment, the biological specimen may include urine; and the reagent may include picric acid using creatinine as the target material, or polyvinylpyrrolidone using microalbumin as the target material.

### BRIEF DESCRIPTION OF THE DRAWINGS

The inventive concept will become more apparent in view of the attached drawings and accompanying detailed description.

FIG. 1 is a cross-sectional view illustrating a bio cartridge according to some embodiments of the inventive concept;

FIGS. 2A and 2B are cross-sectional views illustrating a diagnosing method using a bio cartridge according to some embodiments of the inventive concept;

FIG. 3 is a cross-sectional view illustrating a bio cartridge according to other embodiments of the inventive concept; and

FIG. 4 is a cross-sectional view illustrating a bio cartridge according to still other embodiments of the inventive concept.

### DETAILED DESCRIPTION OF THE EMBODIMENTS

The inventive concept will now be described more fully hereinafter with reference to the accompanying drawings, in which exemplary embodiments of the inventive concept are shown. The advantages and features of the inventive concept and methods of achieving them will be apparent from the following exemplary embodiments that will be described in more detail with reference to the accompanying drawings. It should be noted, however, that the inventive concept is not limited to the following exemplary embodiments, and may be implemented in various forms. Accordingly, the exemplary embodiments are provided only to disclose the inventive concept and let those skilled in the art know the category of the inventive concept. In the drawings, embodiments of the inventive concept are not limited to the specific examples provided herein and are exaggerated for clarity.

The terminology used herein is for the purpose of describing particular embodiments only and is not intended to limit the invention. As used herein, the singular terms “a,” “an” and “the” are intended to include the plural forms as well, unless the context clearly indicates otherwise. As used herein, the term “and/or” includes any and all combinations of one or more of the associated listed items. It will be understood that when an element is referred to as being “connected” or “coupled” to another element, it may be directly connected or coupled to the other element or intervening elements may be present.

Similarly, it will be understood that when an element such as a layer, region or substrate is referred to as being “on” another element, it can be directly on the other element or intervening elements may be present. In contrast, the term “directly” means that there are no intervening elements. It will be further understood that the terms “comprises”, “comprising,”, “includes” and/or “including”, when used herein, specify the presence of stated features, integers, steps, operations, elements, and/or components, but do not preclude the presence or addition of one or more other features, integers, steps, operations, elements, components, and/or groups thereof.

Additionally, the embodiment in the detailed description will be described with sectional views as ideal exemplary views of the inventive concept. Accordingly, shapes of the exemplary views may be modified according to manufacturing techniques and/or allowable errors. Therefore, the embodiments of the inventive concept are not limited to the specific shape illustrated in the exemplary views, but may include other shapes that may be created according to manufacturing processes. Areas exemplified in the drawings have general properties, and are used to illustrate specific shapes of elements. Thus, this should not be construed as limited to the scope of the inventive concept.

It will be also understood that although the terms first, second, third etc. may be used herein to describe various elements, these elements should not be limited by these terms. These terms are only used to distinguish one element from another element. Thus, a first element in some embodiments could be termed a second element in other embodiments without departing from the teachings of the present invention. Exemplary embodiments of aspects of the present inventive concept explained and illustrated herein include their complementary counterparts. The same reference numerals or the same reference designators denote the same elements throughout the specification.

Moreover, exemplary embodiments are described herein with reference to cross-sectional illustrations and/or plane illustrations that are idealized exemplary illustrations. Accordingly, variations from the shapes of the illustrations as a result, for example, of manufacturing techniques and/or tolerances, are to be expected. Thus, exemplary embodiments should not be construed as limited to the shapes of regions illustrated herein but are to include deviations in shapes that result, for example, from manufacturing. For example, an etching region illustrated as a rectangle will, typically, have rounded or curved features. Thus, the regions illustrated in the figures are schematic in nature and their shapes are not intended to illustrate the actual shape of a region of a device and are not intended to limit the scope of example embodiments.

### First Embodiment

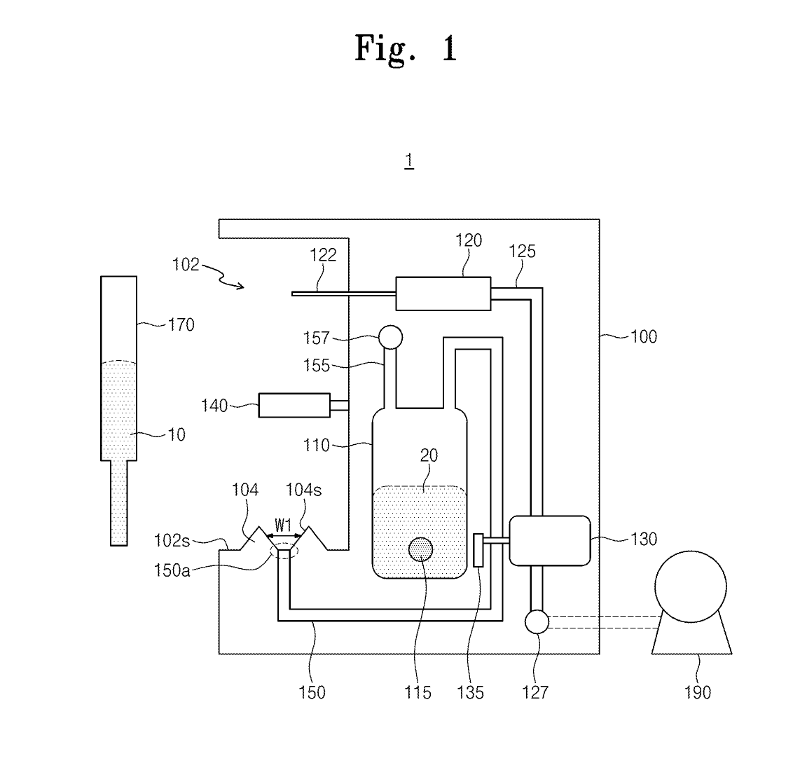

FIG. 1 is a cross-sectional view illustrating a bio cartridge according to some embodiments of the inventive concept.

Referring to FIG. 1, a bio cartridge 1 may include a reaction camber 110 disposed in a housing 100 and storing a reagent 20, a specimen transfer channel 150 guiding a specimen 10 from the outside of the housing 100 into the reaction chamber 110, an air pressure unit 120 applying air pressure to a pipet 170 in which the specimen 10 is stored, and a rotating unit 130 for mixing the specimen 10 provided in the reaction chamber 110 with the reagent 20. The bio cartridge 1 may be a disposable cartridge. In other words, the specimen 10 may be collected and then provided into the bio cartridge 1 in the state that the reagent 20 is previously provided in the bio cartridge 1, such that the bio cartridge 1 may measure a target material in the specimen 10.

The specimen 10 may be collected and then provided into the bio cartridge 1 by the pipet 170. The pipet 170 may be formed of a soft material (e.g., a polymer) in order that a user presses and then releases the pipet 170 to collect the specimen 10. For quantitatively collecting the specimen 10, the pipet 170 may be designed in such a way that a displacement of the pipet 170 is fixed when the pipet 170 is pressed. The pipet 170 may be one of specimen collecting units. The pipet 170 may not be an essential element of the bio cartridge 1. The pipet 170 may be a disposable pipet of a polyethylene material, which may be bought in the market. In another embodiment, the pipet 170 and the bio cartridge 1 may constitute a diagnostic kit.

The housing 100 may include a pipet mounting region 102. One sidewall of the housing 100 may be recessed to define the mounting region 102. A clamp 140 for fixing the pipet 170 may be further installed on a sidewall of the pipet mounting region 102. The clamp 140 may be fixed on the sidewall of the pipet mounting region 102. Alternatively, the clamp 140 may be installed to be movable up and down along the sidewall of the pipet mounting region 102 (i.e., along a longitudinal direction of the pipet 170). The clamp 140 may stably clamp the pipet 170 regardless of a height of the pipet 170.

The reaction chamber 110 may be connected to the specimen transfer channel 150, so as to receive the specimen 10 from the pipet 170. In an embodiment, the bio cartridge 1 may further include an air exhaust channel 155 for exhausting air from the reaction chamber 110. An end of the air exhaust channel 155 may be connected to an air exhaust hole 157. The reagent 20 may be stored in the reaction chamber 110 in advance. The reagent 20 may be in liquid state or in frozen-dried state.

An insertion part 140 may be provided on a bottom surface 102s of the pipet mounting region 102. A bottom end of the pipet 170 may be inserted in the insertion part 140. The insertion part 140 may be connected to an inlet 150a of the specimen transfer channel 150. For example, the insertion part 104 may have a protruding shape and an inner surface 104s inclined downward toward the inlet 150a of the specimen transfer channel 150. In other words, the insertion part 104 may have a funnel-shape of which a width W1 progressively increases as a distance from the inlet 150a of the specimen transfer channel 150 increases. That is, the width W1 of the insertion part 104 may become progressively greater toward a top end of the insertion part 104. Thus, the specimen 10 may be easily provided into the specimen transfer channel 150 and leakage of the specimen 10 may be prevented.

The air pressure unit 120 may include an air transfer channel 125 and an air injecting needle 122. Air provided from the outside may be transferred through the air transfer channel 125, and the air injecting needle 122 may inject the provided air into the pipet 170. An end portion of the air transfer channel 125 may be connected to an air inhaling hole 127, such that the air transfer channel 125 may receive the air from the outside of the housing 100. The air inhaling hole 127 may be opened toward the outside of the housing 100, and the air may be provided into the air pressure unit 120 through the air inhaling hole 127. The air may be provided by an external pump 190 connected to the air inhaling hole 127. In an embodiment, the air pressure unit 120 may be installed within the housing 100, and the air injecting needle 122 may protrude outside the housing 100. For example, the air injecting needle 122 may protrude into the pipet mounting region 102. Thus, the air injecting needle 122 may be inserted into the inside of the pipet 170 mounted in the pipet mounting region 102. If the pipet 170 is formed of a soft material such as polyethylene, the air may not leak even through a hole is created in the pipet 170 by the air injecting needle 122.

According to the present embodiment, the specimen 10 may be forcibly or effectively provided into the bio cartridge 1 by the air pressure of the air pressure unit 120. Unlike the present embodiment, the specimen 10 may be provided into the bio cartridge 1 by a capillary phenomenon method, a micropipette method, or an electrophoresis method. However, in the present embodiment, the specimen 10 may be forcibly provided into the bio cartridge 1 by the air pressure method. Thus, the air pressure method of the present embodiment may be more effective than the capillary phenomenon method, the micropipette method, and the electrophoresis method. Additionally, the air pressure method of the present embodiment may transfer a large volume (e.g., several tens μl to hundreds μl) of specimen.

The rotating unit 130 may include a motor having a magnet 135 installed at an end thereof. The magnet 135 may be connected to a rotating axis of the rotating unit 130. Thus, the magnet 135 may rotate by driving of the rotating unit 130. Additionally, a stirring unit 115 formed of a magnetic material may be provided in the reaction chamber 110. The stirring unit 115 may include a magnetic ball or a magnetic bearing. In another embodiment, the stirring unit 115 may have a bar-shape. The magnet 135 may rotate by the driving of the rotating unit 130 and the stirring unit 115 of the ball shape may rotate on its axis and/or revolve by the rotation of the magnet 135. Thus, the specimen 10 may be actively mixed with the reagent 20. As a result, smooth reaction of the specimen 10 and the reagent 20 may be induced. The rotating unit 130 may be disposed at a sidewall, a front, a back, or a bottom of the reaction chamber 110.

Unlike the present embodiment, a specimen and a reagent may be injected using a microfluidic structure at the same time to induce the mixture of the specimen and the reagent. Generally, in a disposable cartridge, a reagent should be provided in advance and a specimen may be additionally provided. Thus, the mixing method of the specimen and the reagent by the microfluidic structure may not be applied to a disposable cartridge. According to the present embodiment, the specimen 10 may be additionally provided in bio cartridge 1 in the state that the reagent 20 is previously provided in the bio cartridge 1, such that the specimen 10 and the reagent 20 may be mixed with each other. Thus, the bio cartridge 1 according to the present embodiment may be used as the disposable cartridge.

[Diagnosing Method]

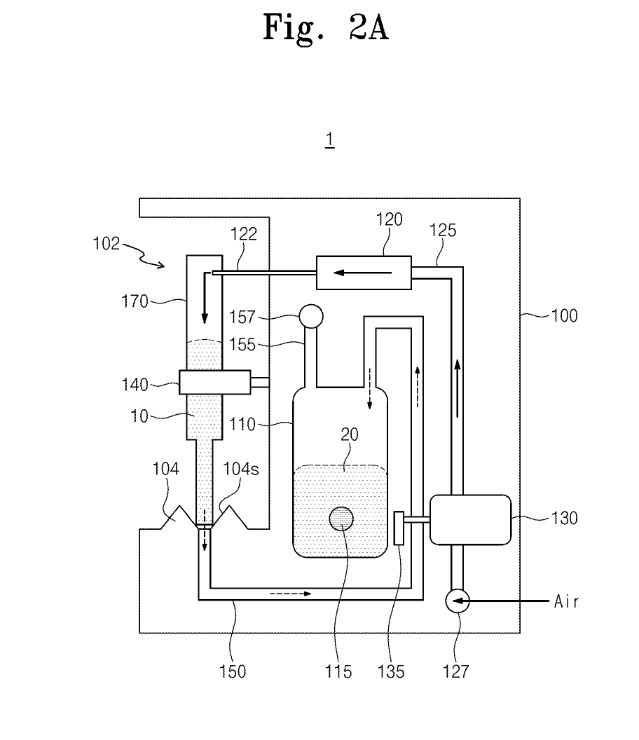

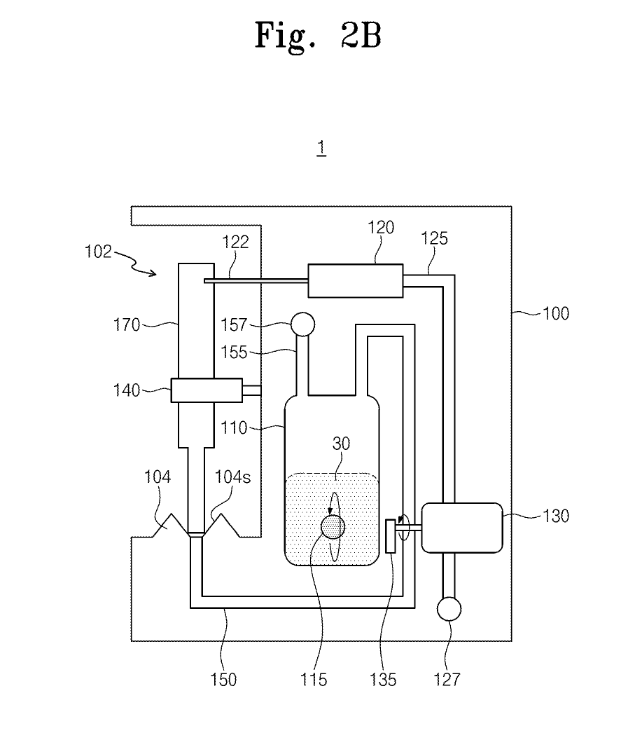

FIGS. 2A and 2B are cross-sectional views illustrating a diagnosing method using a bio cartridge according to some embodiments of the inventive concept.

Referring to FIG. 2A, the specimen 10 may be collected by the pipet 170 and then the pipet 170 may be mounted at the bio cartridge 1. For example, the pipet 170 may be provided in the pipet mounting region 102 and then may be inserted in the insertion part 104. If the clamp 140 is installed, the pipet 170 may be stably fixed by the clamp 140. The air injecting needle 122 may enter into the inside of the pipet 170 when the pipet 170 is inserted into the insertion part 104. The air may be provided by the air pressure unit 120 and then the provided air may be supplied into the pipet 170 through the air injecting needle 122. Thus, the air pressure may occur in the pipet 170. The specimen 10 collected by the pipet 170 may be supplied into the specimen transfer channel 150 by the air pressure. The specimen 10 transferred through the specimen transfer channel 150 may be provided into the reaction chamber 110. In FIG. 2A, a full line arrow shows a flow of the air and a dotted line arrow shows a flow of the specimen 10.

Referring to FIG. 2B, the specimen 10 provided in the reaction chamber 110 may be mixed with the reagent 20 disposed in the reaction chamber 110 to form a mixture 30. The rotating unit 130 may be operated to rotate the magnet 135. The mixture 30 may be uniformly mixed by the stirring unit 115 rotated along the rotated magnet 135. A light transmittance or a light absorbance of the mixture 30 may be measured by a cartridge reader including a light emitting part and a light receiving part.

In an embodiment, the bio cartridge 1 may mix the specimen 10 having a target material with the reagent 20 to measure the light transmittance or light absorbance variation. Thus, the bio cartridge 1 may measure a concentration of the target material. A disease related to the target material may be diagnosed by measuring the concentration of the target material. For example, the specimen 10 may be a biological sample such as urine, and the reagent 20 may include picric acid capable of detecting creatinine in the urine. In this case, the light transmittance of the reagent 20 including picric acid and sodium hydroxide may be measured to set a reference value, as illustrated in FIG. 2A. Next, as illustrated in FIG. 2B, the urine collected by the pipet 170 may be additionally mixed with the reagent 170 and then the light transmittance variation of the mixture 30 may be measured. The measured value of the mixture 30 may be compared with the reference value. The concentration of creatinine may be measured by the variation of the light transmittance, such that a kidney disease may be diagnosed.

In another embodiment, the reagent 20 may include polyvinylpyrrolidone capable of measuring a concentration of microalbumin in the urine. In this case, the concentration of microalbumin may be measured by a light absorbance variation of the mixture 30, thereby diagnosing the kidney disease.

The inventive concept is not limited to the aforementioned examples of the specimen 10 and the reagent 20. The diagnosing method described above is not limited to the bio cartridge 1 according to the aforementioned embodiments. The diagnosing method mentioned above may be applied to other bio cartridges 2 and 3 according to other embodiments described below.

### Second Embodiment

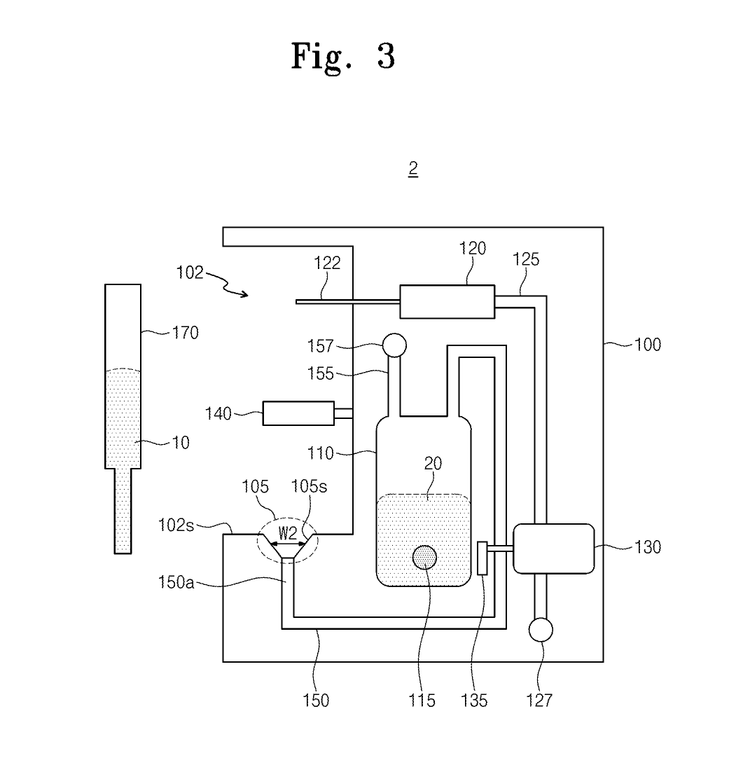

FIG. 3 is a cross-sectional view illustrating a bio cartridge according to other embodiments of the inventive concept.

Referring to FIG. 3, a bio cartridge 2 may include an insertion part 105 recessed from the bottom surface 102s of the pipet mounting region 102. The insertion part 105 may have an inner surface 105s inclined downward toward the inlet 150a of the specimen transfer channel 150. Thus, the insertion part 105 may have a funnel-shape of which a width W2 progressively increases as a distance from the inlet 150a of the specimen transfer channel 150 increases. That is, the width W2 of the insertion part 105 may become progressively greater toward a top end of the insertion part 105. Other elements of the bio cartridge 2 may be the same as or similar to corresponding elements in the bio cartridge 1 of FIG. 1.

### Third Embodiment

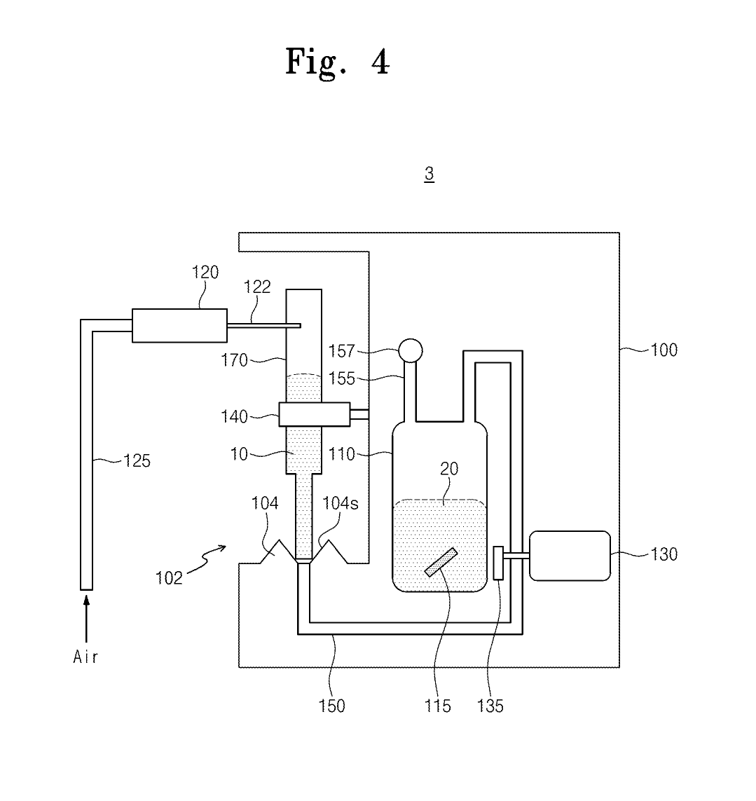

FIG. 4 is a cross-sectional view illustrating a bio cartridge according to still other embodiments of the inventive concept.

Referring to FIG. 4, a bio cartridge 3 may include an air pressure unit 120a that is not installed within the housing 100. For example, the bio cartridge 3 may include a reaction chamber 110 disposed in the housing 110 and storing a reagent 20, a stirring unit 115 disposed in the reaction chamber 110, a specimen transfer channel 150 guiding a specimen 10 from the outside of the housing 100 into the reaction chamber 110, and a rotating unit 130 for mixing the specimen 10 provided into the reaction chamber 110 with the reagent 20.

The air pressure unit 120 may constitute a module or may be included in an additional unit such as a cartridge reader. The stirring unit 115 may be a magnetic bar. In another embodiment, the stirring unit 115 may be a magnetic ball or a magnetic bearing. The insertion part 104 may have a protruding shape as illustrated in FIG. 1. Alternatively, the insertion part 104 may have a recessed shape as illustrated in FIG. 3.

Other elements of the bio cartridge 3 may be the same as or similar to corresponding elements in the bio cartridge 1 of FIG. 1. In another embodiment, the pipet 170 may be designed to generate an air pressure for forcibly providing the specimen 10 into the reaction chamber 110. In this case, the air pressure unit 120 may be omitted.

According to embodiments of the inventive concept, the specimen may be easily transferred into the bio cartridge by the air pressure supplied through the external pump. Additionally, the specimen may be well mixed with the reagent by the magnetic stirring method, such that the specimen may smoothly react with the reagent. Thus, the large volume specimen may be effectively mixed with the reagent. Moreover, the reagent is provided in the bio cartridge in advance, such that the bio cartridge may be used as the disposable cartridge and the specimen may be easily provided into the bio cartridge. Thus, ordinary persons as well as experts may easily use the bio cartridge.

While the inventive concept has been described with reference to example embodiments, it will be apparent to those skilled in the art that various changes and modifications may be made without departing from the spirit and scope of the inventive concept. Therefore, it should be understood that the above embodiments are not limiting, but illustrative. Thus, the scope of the inventive concept is to be determined by the broadest permissible interpretation of the following claims and their equivalents, and shall not be restricted or limited by the foregoing description.

What is claimed is:

1. A bio cartridge comprising:
a reaction chamber in a housing, the reaction chamber storing a reagent;
a specimen transfer channel providing a transfer path through which a specimen is transferred into the reaction chamber;
a mixing unit mixing the specimen with the reagent; and
an air pressure unit providing air pressure to the specimen.

2. The bio cartridge of claim 1, wherein the housing includes a mounting region in which a specimen collection unit capable of collecting the specimen is mounted.

3. The bio cartridge of claim 2, wherein the specimen transfer channel comprises an inlet opened toward the mounting region.

4. The bio cartridge of claim 3, wherein the housing includes an insertion part in which the specimen collection unit is inserted;
wherein the insertion part is connected to the inlet; and
wherein a width of the insertion part becomes progressively less toward the inlet of the specimen transfer channel.

5. The bio cartridge of claim 2, wherein the air pressure unit comprises: an air injecting needle capable of entering into the inside of the specimen collection unit; and an air transfer channel connected to the air injecting needle.

6. The bio cartridge of claim 5, wherein the housing includes an air inhaling hole through which air is inhaled from the outside of the housing,
wherein the air pressure unit is installed within the housing, the air transfer channel is connected to the air inhaling hole, and the air injecting needle protrudes into the mounting region.

7. The bio cartridge of claim 5, wherein the air pressure unit is a distinct module that is not disposed within the housing.

8. The bio cartridge of claim 2, wherein the housing further comprises a clamp installed in the mounting region to clamp the specimen collection unit.

9. The bio cartridge of claim 1, wherein the mixing unit comprises:
a magnetic stirring unit in the reaction chamber along with the reagent; and
a rotating unit providing rotary power to the magnetic stirring unit,
wherein the rotating unit includes a motor having a magnet installed at an end of a rotating axis.

10. The bio cartridge of claim 1, wherein the housing comprises:
an air exhaust channel connected to the reaction chamber, the air exhaust channel providing an exhaust path of air exhausted from the reaction chamber; and
an air exhaust hole connected to the air exhaust channel, the air exhausted through the air exhaust hole.

11. A bio cartridge comprising:
a housing including a mounting region in which a specimen collection unit is mounted, the mounting region having an insertion part in which the specimen collection unit is inserted;
a reaction chamber disposed in the housing, a reagent and a stirring unit disposed in the reaction chamber;
a specimen transfer channel of which first and second ends are connected to the insertion part and the reaction chamber, respectively;
a rotating unit disposed in the housing, the rotating unit generating power capable of rotating the stirring unit; and
an air pressure unit providing air into the specimen collection unit to generate air pressure inside the specimen collection unit.

12. The bio cartridge of claim 11, wherein the insertion part includes a protrusion protruding from a bottom surface of the mounting region; and
wherein the protrusion includes an inner surface inclined downward toward the first end of the specimen transfer channel.

13. The bio cartridge of claim 11, wherein the insertion part includes a recess region recessed from a bottom surface of the mounting region; and
wherein a width of the recess region becomes progressively less from the bottom surface toward the first end of the specimen transfer channel.

14. The bio cartridge of claim 11, wherein the rotating unit includes a motor having a magnet installed at an end of a rotating axis; and
wherein the stirring unit has magnetism to rotate by operation of the motor.

15. The bio cartridge of claim 11, wherein the air pressure comprises: an air injecting needle providing air into the specimen collection unit; and an air transfer channel providing a path transferring the air to the air injecting needle;
wherein the air pressure unit is disposed in the housing; and
wherein the air injecting needle protrudes into the mounting region so as to be inserted into the specimen collection unit.

16. The bio cartridge of claim 11, wherein the housing further comprises:
a clamp installed in the mounting region,
wherein the clamp is movable along a longitudinal direction of the specimen collection unit.

17. A bio cartridge comprising:
a housing in which a reaction chamber is provided, the reaction chamber receiving a biological specimen from a pipet collecting the biological specimen and containing a reagent reacting with a target material in the biological specimen,
wherein the housing comprises:
an air pressure unit including an air injecting needle and an air transfer channel, the air injecting needle inserted into the pipet to provide air into the pipet, and the air transfer channel providing a path through which air injected from the outside of the housing is transferred to the air injecting needle;
a specimen transfer channel providing a path through which the biological specimen is transferred from the pipet to the reaction chamber; and
a mixing unit including a stirring unit disposed in the reaction chamber and a motor generating rotary power capable of rotating the stirring unit, the motor having a magnet installed at an end of a rotating axis,
wherein the air pressure unit generates air pressure inside the pipet to transfer the biological specimen into the reaction chamber through the specimen transfer channel; and
wherein the mixing unit rotates the stirring unit by driving of the motor to mix the biological specimen transferred in the reaction chamber with the reagent stored in the reaction chamber.

18. The bio cartridge of claim 17, wherein the housing includes a pipet mounting region defined by a recessed sidewall of the housing;
wherein an insertion part of a funnel-shape is provided in the pipet mounting region; and
wherein the pipet is inserted in the insertion part.

19. The bio cartridge of claim 17, wherein the stirring unit has a ball, bearing or bar shape having magnetism.

20. The bio cartridge of claim 17, wherein the biological specimen includes urine; and
wherein the reagent includes picric acid using creatinine as the target material, or polyvinylpyrrolidone using microalbumin as the target material.
